(19) United States
(12) Patent Application Publication
(10) Pub. No.: US 2025/0132525 A1
(43) Pub. Date: Apr. 24, 2025

(54) DATA TRANSMISSION DEVICE, DATA TRANSFER SYSTEM AND DATA TRANSFER METHOD

(71) Applicant: Getac Technology Corporation, New Taipei (TW)

(72) Inventor: Yu Jen Tu, Taipei (TW)

(21) Appl. No.: 18/887,127

(22) Filed: Sep. 17, 2024

(30) Foreign Application Priority Data
Oct. 20, 2023 (CN) 202311365502.X

(51) Int. Cl. H01R 13/645; G06F 13/40

(52) U.S. Cl. CPC H01R 13/6453; G06F 13/4072

(57) ABSTRACT

A data transmission device includes a reversible pluggable connection port, a memory and a processor. The reversible pluggable connection port includes a plurality of upper pins and a plurality of lower pins arranged oppositely, wherein the plurality of upper pins include a first identification pin, and the plurality of lower pins include a second identification pin. The processor is connected to the reversible pluggable connection port and the memory, and is configured to output data stored in the memory through the reversible pluggable connection port when detecting a specified signal through the first identification pin, and output a data request signal through the reversible pluggable connection port when detecting the specified signal through the second identification pin.

### CROSS-REFERENCE TO RELATED APPLICATIONS

This non-provisional application claims priority under 35 U.S.C. § 119 (a) on Patent Application No(s). 202311365502.X filed in China on October 20, 2023, the entire contents of which are hereby incorporated by reference.

### BACKGROUND

### 1. Technical Field

This disclosure relates to a data transmission device, data transfer system and data transfer method.

### 2. Related Art

As a tool for data storage and data transmission, portable hard drives are commonly used. Users only need to insert the portable hard drive into their personal devices to store or transfer data to their personal devices. However, the data transmission described above requires human operation, making the process time-consuming and error-prone.

### SUMMARY

Accordingly, this disclosure provides a data transmission device, data transfer system and data transfer method.

According to one or more embodiment of this disclosure, a data transmission device includes a reversible pluggable connection port, a memory and a processor. The reversible pluggable connection port includes a plurality of upper pins and a plurality of lower pins arranged oppositely, wherein the plurality of upper pins include a first identification pin, and the plurality of lower pins include a second identification pin. The processor is connected to the reversible pluggable connection port and the memory, and is configured to output data stored in the memory through the reversible pluggable connection port when detecting a specified signal through the first identification pin, and output a data request signal through the reversible pluggable connection port when detecting the specified signal through the second identification pin.

According to one or more embodiment of this disclosure, a data transfer system includes a portable hard drive and a data transmission device. The data transmission device includes a reversible pluggable connection port, a memory and a processor. The reversible pluggable connection port is configured to be connected to the portable hard drive and includes a plurality of upper pins and a plurality of lower pins arranged oppositely, wherein the plurality of upper pins include a first identification pin, and the plurality of lower pins include a second identification pin. The processor is connected to the reversible pluggable connection port and the memory, and is configured to output data stored in the memory to the portable hard drive through the reversible pluggable connection port when detecting a specified signal through the first identification pin, and output a data request signal to the portable hard drive through the reversible pluggable connection port when detecting the specified signal through the second identification pin.

According to one or more embodiment of this disclosure, a data transfer method is applicable to a portable hard drive and a data transmission device. The data transfer method includes using the data transmission device to execute: outputting stored data to the portable hard drive through a reversible pluggable connection port when detecting a specified signal through a first identification pin of a plurality of upper pins of the reversible pluggable connection port, and outputting a data request signal to the portable hard drive through the reversible pluggable connection port when detecting the specified signal through a second identification pin of a plurality of lower pins of the reversible pluggable connection port.

In view of the above description, the data transmission device, data transfer system and data transfer method may perform the first function of data output or data restoration when the data transmission device detects a specified signal through the first identification pin (i.e., detects that the portable hard drive is inserted with the first side) by disposing an identification pin on the upper pins and the lower pins of the reversible pluggable connection port respectively; and may perform the second function of retrieving data or data backup when the data transmission device detects the specified signal through the second identification pin (i.e., detects that the portable hard drive is inserted with the second side). In this way, additional operations required for data transfer can be reduced to optimize the process and efficiency of data transfer for saving time.

### BRIEF DESCRIPTION OF THE DRAWINGS

The present disclosure will become more fully understood from the detailed

description given hereinbelow and the accompanying drawings which are given by way of illustration only and thus are not limitative of the present disclosure and wherein:

FIG. 1 is a block diagram of a data transmission device according to an embodiment of the present disclosure;

FIG. 2 is a block diagram of a data transfer system according to an embodiment

of the present disclosure;

FIG. 3 is a schematic diagram of a reversible pluggable connection port of a data transmission device according to an embodiment of the present disclosure; and

FIG. 4 is a flow chart of a data transmission method according to an embodiment of the present disclosure.

### DETAILED DESCRIPTION

In the following detailed description, for purposes of explanation, numerous specific details are set forth in order to provide a thorough understanding of the disclosed embodiments. According to the description, claims and the drawings disclosed in the specification, one skilled in the art may easily understand the concepts and features of the present invention. The following embodiments further illustrate various aspects of the present invention, but are not meant to limit the scope of the present invention.

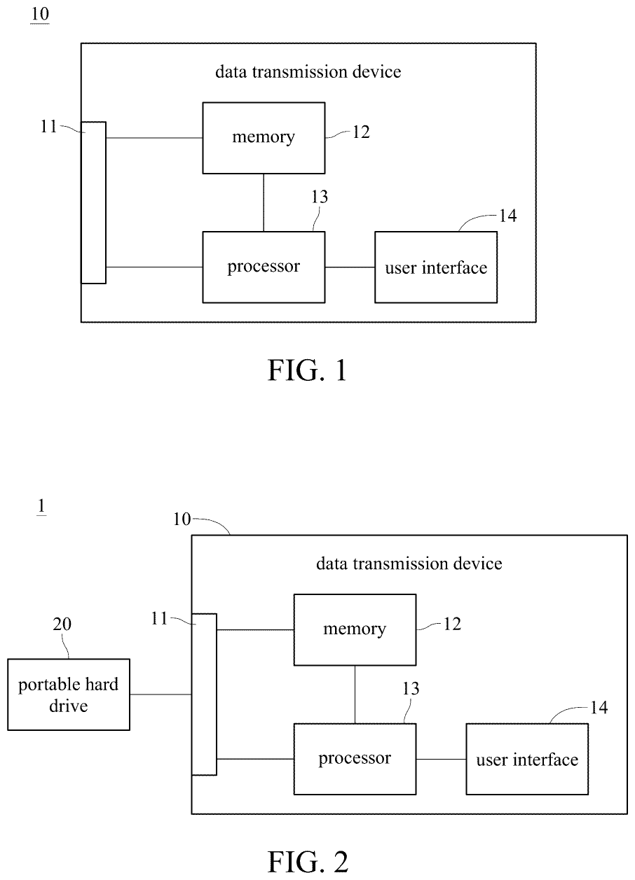

Please refer to FIG. 1 which is a block diagram of a data transmission device according to an embodiment of the present disclosure. As shown in FIG. 1, a data transmission device 10 includes a reversible pluggable connection port 11, a memory 12 and a processor 13. The reversible pluggable connection port 11 includes a plurality of upper pins and a plurality of lower pins arranged oppositely, wherein the plurality of upper pins include a first identification pin, and the plurality of lower pins include a second identification pin. The processor 13 is connected to the reversible pluggable connection port 11 and the memory 12, and is configured to output data stored in the memory 12 through the reversible pluggable connection port 11 when detecting a specified signal through the first identification pin, and output a data request signal through the reversible pluggable connection port 11 when detecting the specified signal through the second identification pin.

In the present embodiment, the data transmission device 10 may be a personal computer. The reversible pluggable connection port 11 includes a plurality of pins, some of the pins are used for transmitting and receiving data, and the other pins are used for identifying connected external devices. The multiple pin positions of the reversible pluggable connection port 11 may be divided into upper pin positions and lower pin positions. The reversible pluggable connection port 11 may be connected to the front or back side of a connector. That is, the upper pins or the lower pins of the reversible pluggable connection port 11 may be connected to a connector. For example, the reversible pluggable connection port 11 may be a USB Type-C port, but the present disclosure is not limited thereto. The memory 12 may be a non-volatile memory, such as a read-only memory. The processor may be a microcontroller, a central processing unit, a programmable logic controller, etc.

When an external device is connected to the data transmission device 10 through the reversible pluggable connection port 11, the processor 13 may determine whether the external device is connected to the reversible pluggable connection port 11 through the front side or the back side. Specifically, the processor 13 may output data stored in the memory 12 through the reversible pluggable connection port 11 when detecting a specified signal through the first identification pin (that is, detecting that an external device is plugged in with the front side). The processor 13 may output a data request signal through the reversible pluggable connection port 11 when detecting the specified signal through the second identification pin (that is, detecting that the external device is plugged in with the back side). In other words, the data in the memory 12 may be transferred to the external device or the data in the memory 12 may be backed up to the external device when the processor 13 detects the specified signal through the first identification pin. The processor 13 may send a data request signal to the external device or allow the external data of the external device to be restored into the memory 12 of the data transmission device 10 when the processor 13 detects the specified signal through the second identification pin.

In addition, as shown in FIG. 1, the data transmission device 10 of the present embodiment may further include a user interface 14 connected to the processor 13, wherein the processor 13 may be further configured to send a confirmation message through the user interface 14 when a specified signal is detected through the first identification pin or the second identification pin. In the present embodiment, the user interface 14 may be a screen. Specifically, when the user inserts one side of the external device into the reversible pluggable connection port 11, the processor 13 may send a confirmation message through the user interface 14 based on a specified signal detected by the first identification pin or the second identification pin to ensure that the user may perform a desired function. Further, when the user inserts the external device (such as a portable hard drive) into the data transmission device 10 with the backup side, the user may choose to back up all data or only choose to back up specific data to the portable hard drive through setting options of the user interface 14. At the same time, the user interface 14 may also provide the option of restoring the original factory settings, so that the user may restore the data transmission device to the original system state while selecting the backup.

Please refer to FIG. 2 which is a block diagram of a data transfer system according to an embodiment of the present disclosure. As shown in FIG. 2, a data transfer system 1 includes a portable hard drive 20 and a data transmission device 10. The data transmission device 10 includes a reversible pluggable connection port 11, a memory 12 and a processor 13. The reversible pluggable connection port 11 is configured to be connected to the portable hard drive 20 and includes a plurality of upper pins and a plurality of lower pins arranged oppositely, wherein the plurality of upper pins include a first identification pin, and the plurality of lower pins include a second identification pin. The processor 13 is connected to the reversible pluggable connection port 11 and the memory 12, and is configured to output data stored in the memory 12 to the portable hard drive 20 through the reversible pluggable connection port 11 when detecting a specified signal through the first identification pin, and output a data request signal to the portable hard drive 20 through the reversible pluggable connection port 11 when detecting the specified signal through the second identification pin.

The data transmission device 10 in FIG. 2 is basically the same as the data transmission device 10 in FIG. 1 and is not described repeatedly herein. In the present embodiment, the portable hard drive 20 has a connector corresponding to the reversible pluggable connection port 11, specifically a Universal Serial Bus (USB) Type-C connector. When the portable hard drive 20 is connected to the data transmission device 10 through the reversible pluggable connection port 11, the processor 13 may determine whether the portable hard drive 20 is connected to the reversible pluggable connection port 11 through the front or back side. Specifically, the processor 13 may output data stored in the memory 12 to the portable hard drive 20 through the reversible pluggable connection port 11 when detecting a specified signal through the first identification pin (that is, detecting that the portable hard drive 20 is plugged in with the front side). The processor 13 may output a data request signal to the portable hard drive 20 through the reversible pluggable connection port 11 when detecting the specified signal through the second identification pin (that is, detecting that the portable hard drive 20 is plugged in with the back side).

That is, the data in the memory 12 may be transferred to the portable hard drive 20 or the data in the memory 12 may be backed up to the portable hard drive 20 when the processor 13 detects the specified signal through the first identification pin. The processor 13 may send a data request signal to the portable hard drive 20 or allow the external data of the portable hard drive 20 to be restored into the memory 12 of the data transmission device 10 when the processor 13 detects the specified signal through the second identification pin. In this way, when the portable hard drive 20 is coupled to the data transmission device 10 with the front side, the data of the data transmission device 10 may be backed up; when the portable hard drive 20 is coupled to the data transmission device 10 with the back side, the backed up or stored data may be restored to the data transmission device 10. The portable hard drive 20 may also be used to restore factory settings of multiple data transmission devices 10. In one embodiment, different patterns may be provided on two opposite surfaces of the portable hard drive 20 for user identification.

In addition, as shown in FIG. 2, the data transmission device 10 of the present embodiment may further include a user interface 14 connected to the processor 13, wherein the processor 13 may be further configured to send a confirmation message through the user interface 14 when a specified signal is detected through the first identification pin or the second identification pin. In the present embodiment, the user interface 14 may be a screen. Specifically, when the user inserts one side of the portable hard drive 20 into the reversible pluggable connection port 11, the processor 13 may send a confirmation message through the user interface 14 based on a specified signal detected by the first identification pin or the second identification pin to ensure that the user may perform a desired function.

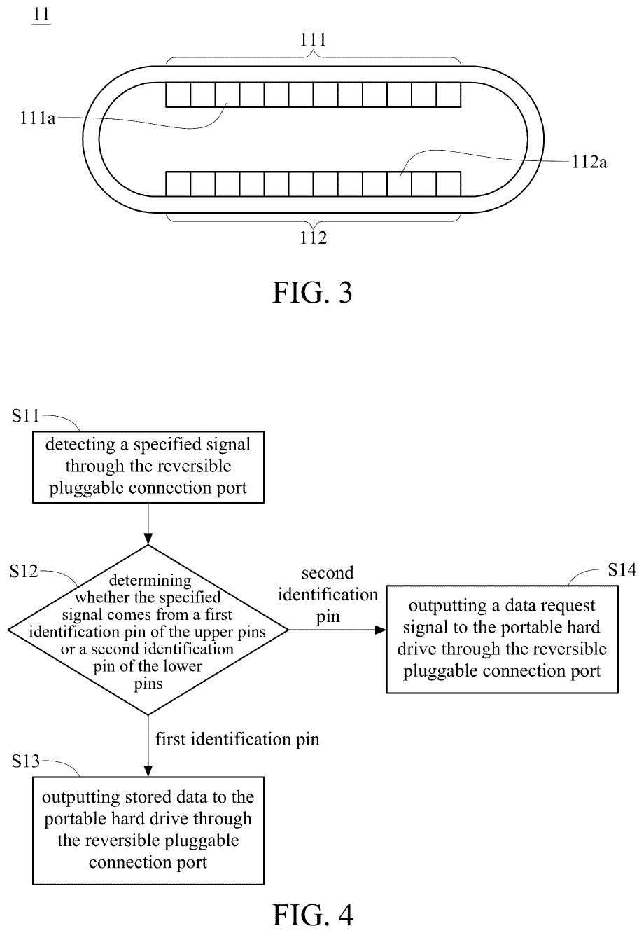

Please refer to FIG. 3 which is a schematic diagram of a reversible pluggable connection port of a data transmission device according to an embodiment of the present disclosure. As shown in FIG. 3, the first identification pin 111a of the reversible pluggable connection port 11 is disposed at a specific sequence from left to right of the plurality of upper pins 111, and the second identification pin 112a is disposed at the specific sequence from right to left of the plurality of lower pins 112. Through this configuration, when the connector of the portable hard drive is connected to the reversible pluggable connection port 11 with the front side, the data transmission device may detect the specified signal through the first identification pin 111a; and when the connector of the portable hard drive is connected to the reversible pluggable connection port 11 with the back side, the data transmission device may detect the specified signal through the second identification pin 112a.

Please refer to FIG. 4 along with FIG. 2, FIG. 4 is a flow chart of a data transmission method according to an embodiment of the present disclosure. As shown in

FIG. 4, a data transfer method includes using the data transmission device 10 and the portable hard drive 20 to execute step S11: detecting a specified signal through the reversible pluggable connection port; step S12: determining whether the specified signal comes from the first identification pin of the upper pins or the second identification pin of the lower pins; if the specified signal comes from the first identification pin, executing step S13: outputting stored data to the portable hard drive through the reversible pluggable connection port; if the specified signal comes from the second identification pin, executing step S14: outputting a data request signal to the portable hard drive through the reversible pluggable connection port.

The execution of the above steps S11 to S14 is basically the same as the description of FIGS. 1 to 3 and is not described repeatedly herein. In addition, the data transfer method described above may further include: sending a confirmation message through the user interface when detecting the specified signal through the first identification pin or the second identification pin. Specifically, the user interface may be a screen. When the user inserts one side of the portable hard drive into the reversible pluggable connection port, the processor may send a confirmation message through the user interface based on the specified signal detected by the first identification pin or the second identification pin.

Based on the embodiments of the data transmission device, data transfer system and data transfer method described above, optional implementation are provided below. In one embodiment, the processor of the data transmission device may be further configured to receive verification information through the reversible pluggable connection port and confirm that the verification information matches pre-stored information before outputting the data stored in the memory or the data request signal. That is, before steps S13 and S14 in FIG. 4, the processor of the data transmission device may first verify the verification information of the portable hard drive (or external device). Through this verification mechanism, the data transmission device in the present embodiment may not only easily backup data to a portable hard drive or restore data from a portable hard drive, but also improve data security. Specifically, when an arbitrary and non-matching portable hard drive is inserted into the data transmission device, the data transmission device may first verify the portable hard drive to avoid backing up important data to other suspicious flash drives, and to avoid backing up important data to other suspicious portable hard drives, and also avoid obtaining harmful data, such as virus codes, etc. from suspicious portable hard drives.

In another embodiment, the processor of the data transmission device may be further configured to receive a driving program from the portable hard drive (or external device) through the reversible pluggable connection port and install the driving program. Further, the processor of the data transmission device may be configured to activate the driving program when the specified signal is detected through the first identification pin or the second identification pin. The processor may output data stored in the memory or the data request signal through the reversible pluggable connection port after activating the driving program. Specifically, the portable hard drive 20 in FIG. 2 may store a driving program in advance. When the portable hard drive 20 is connected to the reversible pluggable connection port 11 of the data transmission device 10, the processor 13 of the data transmission device 10 may install the driving program to obtain software resources, and activate the driving program and the specific operating interface to perform data backup or data restoration functions.

In view of the above description, the data transmission device, data transfer

system and data transfer method may perform the first function of data output or data restoration when the data transmission device detects a specified signal through the first identification pin (i.e., detects that the portable hard drive is inserted with the first side) by disposing an identification pin on the upper pins and the lower pins of the reversible pluggable connection port respectively; and may perform the second function of retrieving data or data backup when the data transmission device detects the specified signal through the second identification pin (i.e., detects that the portable hard drive is inserted with the second side). In this way, additional operations required for data transfer can be reduced to optimize the process and efficiency of data transfer for saving time. In addition, by pre-saving the driving program in the portable hard drive, the data transmission device automatically installs the driving program and starts the software supporting system to perform subsequent data restoration or data backup when the portable hard drive is connected to the data transmission device, which is convenient for users to operate.

What is claimed is:

1. A data transmission device, comprising:
a reversible pluggable connection port comprising a plurality of upper pins and a plurality of lower pins arranged oppositely, wherein the plurality of upper pins comprise a first identification pin, and the plurality of lower pins comprise a second identification pin;
a memory; and
a processor connected to the reversible pluggable connection port and the memory, and configured to output data stored in the memory through the reversible pluggable connection port when detecting a specified signal through the first identification pin, and output a data request signal through the reversible pluggable connection port when detecting the specified signal through the second identification pin.

2. The data transmission device of claim 1, wherein the first identification pin is disposed at a specific sequence from left to right of the plurality of upper pins, and the second identification pin is disposed at the specific sequence from right to left of the plurality of lower pins.

3. The data transmission device of claim 1, wherein the processor is further configured to receive verification information through the reversible pluggable connection port and confirm that the verification information matches pre-stored information before outputting the data stored in the memory or the data request signal.

4. The data transmission device of claim 1, wherein the processor is further configured to receive a driving program through the reversible pluggable connection port and install the driving program.

5. The data transmission device of claim 4, wherein the processor is configured to activate the driving program when detecting the specified signal through the first identification pin or the second identification pin, and output the data stored in the memory or the data request signal through the reversible pluggable connection port after activating the driving program.

6. The data transmission device of claim 1, further comprising a user interface connected to the processor, wherein the processor is further configured to send a confirmation message through the user interface when detecting the specified signal through the first identification pin or the second identification pin.

7. A data transfer system, comprises:
a portable hard drive; and
a data transmission device, comprising:
a reversible pluggable connection port configured to be connected to the portable hard drive, and comprising a plurality of upper pins and a plurality of lower pins arranged oppositely, wherein the plurality of upper pins include a first identification pin, and the plurality of lower pins include
a second identification pin;
a memory; and
a processor connected to the reversible pluggable connection port and the memory, and configured to output data stored in the memory to the portable hard drive through the reversible pluggable connection port when detecting a specified signal of the portable hard drive through the first identification pin, and output a data request signal to the portable hard drive through the reversible pluggable connection port when detecting the specified signal through the second identification pin.

8. The data transfer system of claim 7, wherein the portable hard drive has a front side and a back side, and is configured to back up data of a first device when connected to the first device with the front side, and restore the data that is backed up to a second device when connected to the second device with the back side, wherein the first device and the second device are the data transmission device.

9. The data transfer system of claim 7, wherein the first identification pin is disposed at a specific sequence from left to right of the plurality of upper pins, and the second identification pin is disposed at the specific sequence from right to left of the plurality of lower pins.

10. The data transfer system of claim 7, wherein the processor is further configured to receive verification information through the reversible pluggable connection port and confirm that the verification information matches pre-stored information before outputting the data stored in the memory or the data request signal.

11. The data transfer system of claim 7, wherein the processor is further configured to receive a driving program through the reversible pluggable connection port and install the driving program.

12. The data transfer system of claim 11, wherein the processor is configured to activate the driving program when detecting the specified signal through the first identification pin or the second identification pin, and output the data stored in the memory or the data request signal through the reversible pluggable connection port after activating the driving program.

13. The data transfer system of claim 7, wherein the data transmission device further comprises a user interface connected to the processor, wherein the processor is further configured to send a confirmation message through the user interface when detecting the specified signal through the first identification pin or the second identification pin.

14. A data transfer method, applicable to a portable hard drive and a data transmission device, the data transfer method comprising using the data transmission device to execute:
outputting stored data to the portable hard drive through a reversible pluggable connection port when detecting a specified signal through a first identification pin of a plurality of upper pins of the reversible pluggable connection port; and
outputting a data request signal to the portable hard drive through the reversible pluggable connection port when detecting the specified signal through a second identification pin of a plurality of lower pins of the reversible pluggable connection port.

15. The data transfer method of claim 14, wherein the first identification pin is disposed at a specific sequence from left to right of the plurality of upper pins, and the second identification pin is disposed at the specific sequence from right to left of the plurality of lower pins.

16. The data transfer method of claim 14, further comprising:
receiving verification information through the reversible pluggable connection port, and confirming that the verification information matches pre-stored information before outputting the stored data or the data request signal.

17. The data transfer method of claim 14, further comprising:
receiving a driving program through the reversible pluggable connection port and installing the driving program.

18. The data transfer method of claim 17, further comprising:
activating the driving program when detecting the specified signal through the first identification pin or the second identification pin and outputting the stored data or the data request signal through the reversible pluggable connection port after activating the driving program.

19. The data transfer method of claim 14, further comprising:
sending a confirmation message through a user interface when detecting the specified signal through the first identification pin or the second identification pin.
